(19) United States
(12) Patent Application Publication
(10) Pub. No.: US 2014/0001326 A1
(43) Pub. Date: Jan. 2, 2014

(54) MOUNTING APPARATUS FOR DUPLEX MODULE OF PRINTER

(71) Applicant: CHI-JUNG TSAI, Tu-Cheng (TW)

(72) Inventor: CHI-JUNG TSAI, Tu-Cheng (TW)

(73) Assignee: HON HAI PRECISION INDUSTRY CO., LTD., Tu-Cheng (TW)

(21) Appl. No.: 13/588,031

(22) Filed: Aug. 17, 2012

(30) Foreign Application Priority Data
Jun. 29, 2012 (TW) 101123438

(51) Int. Cl. B41J 35/00; F16M 13/00

(52) U.S. Cl. 248/231.51; 248/316.5

(57) ABSTRACT

A mounting apparatus for a duplex module of a printer, includes a bracket, a left lock hung on a left portion of the bracket, a right lock hung on a right portion of the bracket; and a left transmission module and a right transmission module movably mounted on the bracket. The duplex module is secured to the bracket. The left transmission module abuts the left lock. The right transmission module abuts the right lock. The left transmission module and the right transmission module move synchronously to move the left lock and the right lock synchronously to attach the duplex module to the printer or detach the duplex module from the printer.

### BACKGROUND

1. Technical Field

The present disclosure relates to mounting apparatuses, and more particularly to a mounting apparatus for a duplex module of a printer.

2. Description of Related Art

Duplex printing is a desirable feature in printing systems. The advantages of duplex printing include reducing the sheets of paper required as compared to one-side (simplex) printing, and generating print sets with layouts resembling that of professionally printed books. The sheets of paper may be jammed in a duplex module when duplex printing a sheet of paper. As such the duplex module may need to be detached. However, the duplex module is usually mounted in the printer via screws. It may be tedious to detach the screws and re-attach the screws one by one to disassemble or assemble the duplex module.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of an embodiment of a mounting apparatus for a duplex module of a printer.

FIG. 2 is similar to FIG. 1, but viewed from another aspect.

FIG. 3 is an assembled view of the mounting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

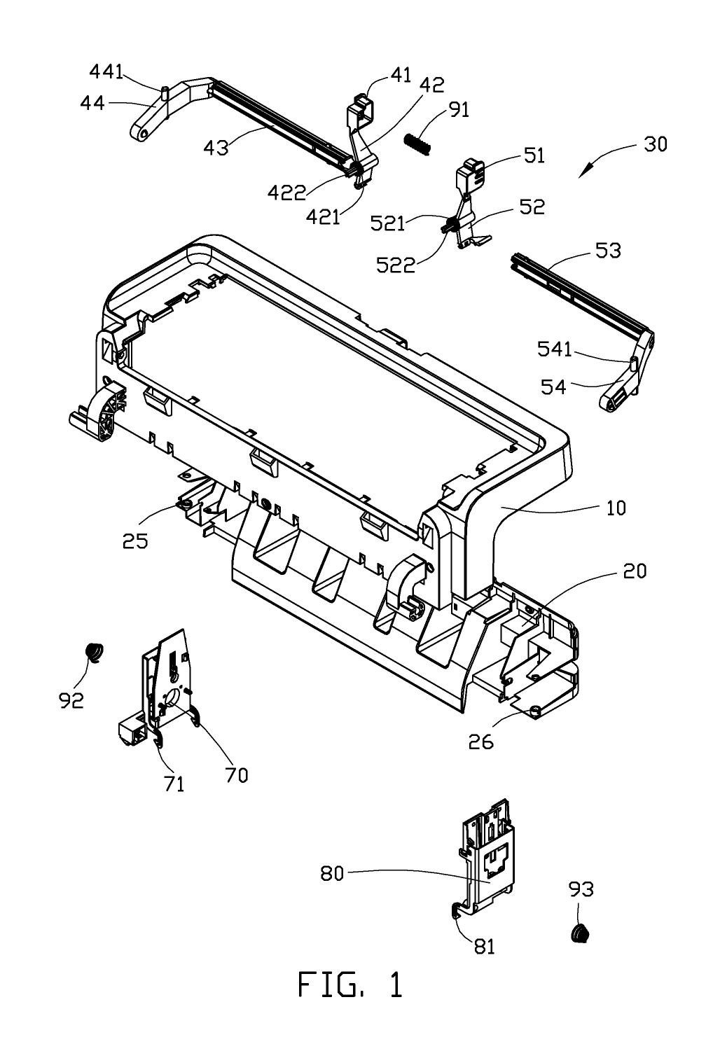

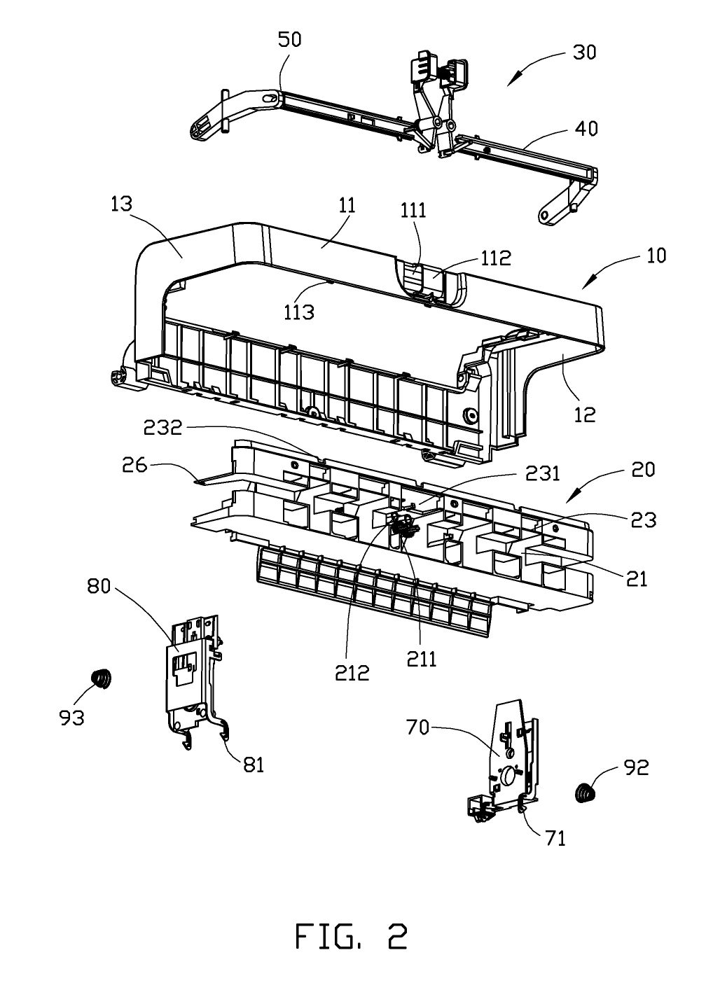

Referring to FIGS. 1 and 2, a mounting apparatus for a duplex module of a printer in accordance with an embodiment is shown. The mounting apparatus includes a first bracket 10, a second bracket 20, a transmission assembly 30, a left lock 70, and a right lock 80. The duplex module is mounted on the first bracket 10 and the second bracket 20.

The first bracket 10 includes a rear plate 11, a left side plate 12, and a right side plate 13. The left side plate 12 is perpendicularly connected to a left edge of the rear plate 11. The right side plate 13 is perpendicularly connected to a right edge of the rear plate 11. The rear plate 11 defines a receiving hole 111. A restricting piece 112 is connected to the rear plate 11 and aligned to the receiving hole 111. A bottom edge of the rear plate 11 forms a plurality of clasps 113.

The second bracket 20 includes a front plate 21 and a top plate 23. A pair of synchromesh gears 211 is pivotally mounted on the front plate 21. A pair of first pivot holes 212 is defined in the front plate 21 and located above the pair of synchromesh gears 211. An opening 231 is defined in the top plate 23. The opening 231 is aligned with the pair of synchromesh gears 211. The top plate 23 defines a plurality of engaging holes 232 corresponding to the plurality of clasps 113. A pair of second pivot holes 25 is defined in a left portion of the second bracket 20. A pair of third pivot holes 26 are defined in a right portion of the second bracket 20.

The transmission assembly 30 includes a left transmission module 40 and a right transmission module 50. The left transmission module 40 includes a left pressing block 41, a first left lever 42, a left transmission lever 43, and a second left lever 44. A left gear 421 is connected to a middle portion of the first left lever 42. The left gear 421 includes a first shaft 422. A pair of first axles 441 is equipped on a middle portion of the second left lever 44.

The right transmission module 50 includes a right pressing block 51, a first right lever 52, a right transmission lever 53, and a second right lever 54. A right gear 521 is connected to a middle portion of the first right lever 52. The right gear 521 includes a second shaft 522. A pair of second axles 541 is equipped on a middle portion of the second right lever 54.

The left lock 70 is generally a piece and can be elastically bent. An upper portion of the left lock 70 can be mounted on the left side plate 12 of the first bracket 10. A pair of first hooks 71 is connected to a lower portion of the left lock 70.

The right lock 80 is generally a piece of plate and can be elastically bent. An upper portion of the right lock 80 can be mounted on the right side plate 13 of the first bracket 10. A pair of second hooks 81 is connected to a lower portion of the right lock 80.

A first spring 91 can be mounted between the left pressing block 41 and the right pressing block 51. A second spring 92 can be mounted between the second left lever 44 and the left lock 70. A third spring 93 can be mounted between the second right lever 54 and the right lock 80.

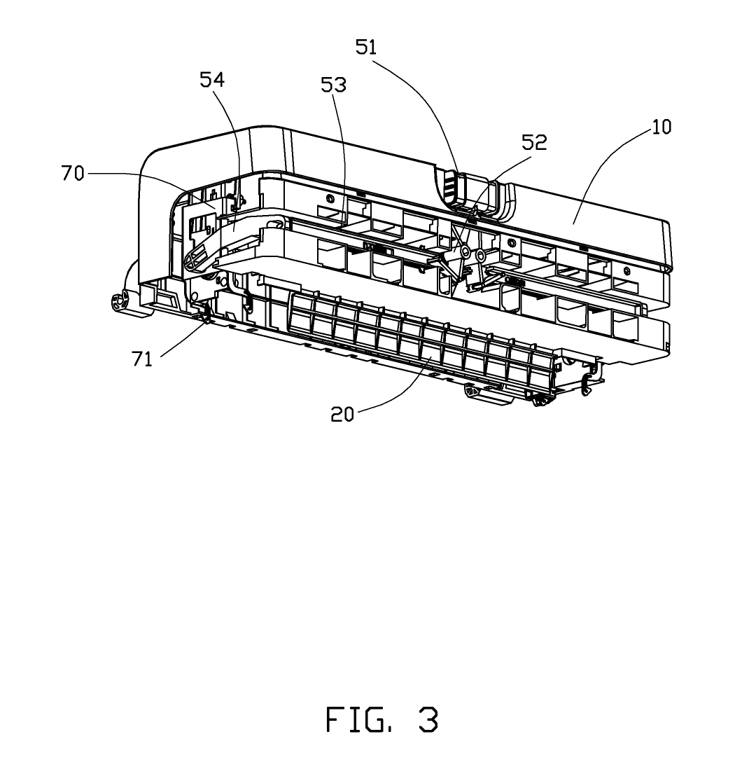

Referring to FIGS. 1 to 3, during assembly, the left pressing block 41 and the right pressing block 51 are placed between the rear plate 11 and the restricting piece 112. The first spring 91 is sandwiched between the left pressing block 41 and the right pressing block 51.

The first shaft 422 of first left lever 42 is pivotally mounted in one of the pair of first pivot holes 212. The left gear 421 meshes with one of the pair of synchromesh gears 211. The pair of first axles 441 of the second left lever 44 are pivotally mounted in the pair of second pivot holes 25 of the second bracket 20. The left transmission lever 43 is slidably located on the second bracket 20. One end of the left transmission lever 43 abuts a bottom end of the first left lever 42. Another end of the left transmission lever 43 abuts a rear end of the second left lever 44.

The second shaft 522 of the first right lever 52 is pivotally mounted in the other one of the pair of first pivot holes 212. The right gear 521 meshes with the other one of the pair of synchromesh gears 211. The pair of second axles 541 of the second right lever 54 are pivotally mounted in the pair of third pivot holes 26 of the second bracket 20. The right transmission lever 53 is slidably located on the second bracket 20. One end of the right transmission lever 53 abuts a bottom end of the first right lever 52. The other end of the right transmission lever 53 abuts a rear end of the second right lever 54.

The plurality of clasps 113 of the first bracket 10 are engaged in the plurality of engaging holes 232 of the second bracket 20 to secure the first bracket 10 and the second bracket 20 together. A top end of the first left lever 42 is inserted through the opening 231 and abuts the left pressing block 41. A top end of the first right lever 52 inserts through the opening 231 and abuts the right pressing block 51. The upper portion of the left lock 70 is mounted on the left side plate 12 of the first bracket 10. The second spring 92 is sandwiched between a front end of the second left lever 44 and the lower portion of the left lock 70. The upper portion of the right lock 80 is mounted on the right side plate 13 of the first bracket 10. The third spring 93 is sandwiched between a front end of the second right lever 54 and the lower portion of the right lock 80.

In work, the left pressing block 41 and the right pressing block 51 are pressed to move toward each other. The first spring 91 is elastically compressed. The left pressing block 41 moves to rotate the first left lever 42. The right pressing block 51 moves to rotate the first right lever 52. Because the left gear 421 and the right gear 521 mesh with the pair of synchromesh gears 211, the first left lever 42 and the first right lever 52 are kept rotating in synch. The bottom end of the first left lever 42 pushes the left transmission lever 43 to move. The bottom end of the first right lever 52 pushes the right transmission lever 53 to move. The left transmission lever 43 pushes the rear end of the second left lever 44 to rotate the second left lever 44. The right transmission lever 53 pushes the rear end of the second right lever 54 to rotate the second right lever 54. The front end of the second left lever 44 abuts and pushes the lower portion of the left lock 70 via the second spring 92. The second spring 92 is elastically compressed. The front end of the second right lever 54 abuts and pushes the lower portion of the right lock 80 via the third spring 93. Therefore, the pair of first hooks 71 of the left lock 70 and the pair of second hooks 81 of the right lock 80 move towards each other in synch.

To mount the duplex module, the first bracket 10 and the second bracket 20 are placed in a printer with the left pressing block 41 and the right pressing block 51 being pressed. The left pressing block 41 and the right pressing block 51 are then released. The pair of first hooks 71 and the pair of second hooks 81 move backward to engage the printer for mounting the first bracket 10 and the second bracket 20 on the printer. Therefore, the duplex module is mounted in the printer.

To detach the duplex module, the left pressing block 41 and the right pressing block 51 are pressed to move toward each other. The pair of first hooks 71 of the left lock 70 and the pair of second hooks 81 of the right lock 80 move towards each other in synch to disengage the printer. Therefore, the duplex module is detached easily.

In the mounting apparatus, the left gear 421 and the right gear 521 mesh with the pair of synchromesh gears 211, so the left transmission module 40 and the right transmission module 50 work in synch, which keeps the pair of first hooks 71 and the pair of second hooks 81 moving synchronously.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A mounting apparatus for a duplex module of a printer, comprising:
a bracket configured to secure the duplex module;
a left lock hung on a left portion of the bracket, a right lock hung on a right portion of the bracket; and
a left transmission module and a right transmission module, each of the left transmission module and the right transmission module being movably mounted on the bracket; and
wherein the left transmission module abuts the left lock, the right transmission module abuts the right lock; the left transmission module and the right transmission module are configured to move synchronously to move the left lock and the right lock synchronously to attach the duplex module to the printer or detach the duplex module from the printer.

2. The mounting apparatus of claim 1, wherein the left transmission module comprises a left gear, the right transmission module comprises a right gear, a pair of synchromesh gears are pivotally mounted on the bracket, the left gear meshes with one of the pair of synchromesh gears, and the right gear meshes with another one of the pair of synchromesh gears.

3. The mounting apparatus of claim 1, wherein the left transmission module comprises a left pressing block and a first left lever, a middle portion of the first left lever is pivotally mounted on the bracket, one end of the first left lever abuts the left pressing block, another end of the first left lever abuts the left lock; the right transmission module comprises a right pressing block and a first right lever, a middle portion of the first right lever is pivotally mounted on the bracket, one end of the first right lever abuts the right pressing block, another end of the first right lever abuts the right lock; the left pressing block and the right pressing block are configured to be pressed to move toward each other.

4. The mounting apparatus of claim 3, wherein a left gear is mounted on the middle portion of the first left lever, a right gear is mounted on the middle portion of the first right left lever; a pair of synchromesh gears are pivotally mounted on the bracket, the left gear meshes with one of the pair of synchromesh gears, and the right gear meshes with another one of the pair of synchromesh gears.

5. The mounting apparatus of claim 3, wherein a first spring is sandwiched between the left pressing block and the right pressing block, and the first spring is configured to be elastically compressed when the left pressing block and right pressing block move toward each other.

6. The mounting apparatus of claim 3, wherein a left transmission lever and a second left lever connect the first left lever to the left lock, and a right transmission lever and a second right lever connect the first right lever to the right lock.

7. The mounting apparatus of claim 6, wherein the bracket comprises a left side plate and a right side plate, the left side plate defines a first pivot hole, the right side plate defines a second pivot hole; a first axis is located on a middle portion of the second left lever, a second axis is located on a middle portion of the second right lever; the first axis is pivotally mounted on the first pivot hole, the second axis is pivotally mounted on the second pivot hole; one end of the second left lever abuts the left transmission lever, and another end of the second left lever abuts the left lock; one end of the second right lever abuts the right transmission lever, and another end of the second right lever abuts the right lock.

8. The mounting apparatus of claim 7, wherein an upper portion of the left lock is secured to the left side plate, a first hook is connected to a lower portion of the left lock, the second left lever abuts the lower portion of the left lock and is configured to elastically bend the lower portion of the left lock; an upper portion of the right lock is secured to the right side plate, a second hook is connected to a lower portion of the right lock, the second right lever abuts the lower portion of the right lock and is configured to elastically bend the lower portion of the right lock.

9. The mounting apparatus of claim 8, wherein the a second spring is sandwiched between the second left lever and the lower portion of the left lock, and a third spring is sandwiched between the second right lever and the lower portion of the right lock.

10. The mounting apparatus of claim 3, wherein the bracket comprises a rear plate, the rear plate defines a receiving hole, and a restricting piece is connected to the rear plate and is aligned to the receiving hole; the left pressing block and the right pressing block are placed between the rear plate and the restricting piece; the first left lever abuts the left pressing block through the receiving hole, and the first right lever abuts the right pressing block through the receiving hole.

11. A mounting apparatus, comprising:
a bracket;
a left lock hung on a left portion of the bracket, a right lock hung on a right portion of the bracket;
a first left lever pivotally mounted on the bracket, a left gear mounted on the first left lever, the first left lever abutting the left lock;
a first right lever pivotally mounted on the bracket, a right gear mounted on the first right lever, the first right lever abutting the right lock; and
a pair of synchromesh gears pivotally mounted on the bracket; wherein the left gear meshes with one of the pair of synchromesh gears, and the right gear meshes with another one of the pair of synchromesh gears; the first left lever and the first right lever are configured to move synchronously with the pair of synchromesh gears to move the left lock and the right lock synchronously.

12. The mounting apparatus of claim 11, further comprising a left pressing block and a right pressing block, wherein a middle portion of the first left lever is pivotally mounted on the bracket, one end of the first left lever abuts the left pressing block, another end of the first left lever abuts the left lock; a middle portion of the first right lever is pivotally mounted on the bracket, one end of the first right lever abuts the right pressing block, another end of the first right lever abuts the right lock; the left pressing block and the right pressing block are configured to be pressed to move toward each other.

13. The mounting apparatus of claim 12, wherein the left gear is mounted on the middle portion of the first left lever, and the right gear is mounted on the middle portion of the first right lever.

14. The mounting apparatus of claim 12, wherein a first spring is sandwiched between the left pressing block and the right pressing block, and the first spring is configured to be elastically compressed when the left pressing block and right pressing block move toward each other.

15. The mounting apparatus of claim 12, wherein the bracket comprises a rear plate, the rear plate defines a receiving hole, and a restricting piece is connected to the rear plate and is aligned to the receiving hole; the left pressing block and the right pressing block are placed between the rear plate and the restricting piece; the first left lever abuts the left pressing block through the receiving hole, and the first right lever abuts the right pressing block through the receiving hole.

16. The mounting apparatus of claim 11, wherein a left transmission lever and a second left lever connect the first left lever to the left lock, and a right transmission lever and a second right lever connect the first right lever to the right lock.

17. The mounting apparatus of claim 16, wherein the bracket comprises a left side plate and a right side plate, the left side plate defines a first pivot hole, the right side plate defines a second pivot hole; a first axis is located on a middle portion of the second left lever, a second axis is located on a middle portion of the second right lever; the first axis is pivotally mounted on the first pivot hole, the second axis is pivotally mounted on the second pivot hole; one end of the second left lever abuts the left transmission lever, and another end of the second left lever abuts the left lock; one end of the second right lever abuts the right transmission lever, and another end of the second right lever abuts the right lock.

18. The mounting apparatus of claim 17, wherein an upper portion of the left lock is secured to the left side plate, a first hook is connected to a lower portion of the left lock, the second left lever abuts the lower portion of the left lock and configured to elastically bend the lower portion of the left lock; an upper portion of the right lock is secured to the right side plate, a second hook is connected to a lower portion of the right lock, the second right lever abuts the lower portion of the right lock and is configured to elastically bend the lower portion of the right lock.

19. The mounting apparatus of claim 18, wherein the a second spring is sandwiched between the second left lever and the lower portion of the left lock, and a third spring is sandwiched between the second right lever and the lower portion of the right lock.
